(19) United States
(12) Patent Application Publication
(10) Pub. No.: US 2026/0348468 A1
(43) Pub. Date: Nov. 5, 2026

(54) FLUID DISCHARGE SYSTEM

(71) Applicant: Tusas- Turk Havacilik Ve Uzay Sanayii Anonim Sirketi, Ankara (TR)

(72) Inventor: Erkan GOKMEN, Ankara (TR)

(73) Assignee: Tusas- Turk Havacilik Ve Uzay Sanayii Anonim Sirketi, Ankara (TR)

(21) Appl. No.: 18/717,445

(22) PCT Filed: Oct. 27, 2022
(86) PCT No.: PCT/TR2022/051191

§ 371 Date: Jun. 7, 2024

(30) Foreign Application Priority Data
Dec. 8, 2021 (TR) 2021/019359

(51) Int. Cl. F16H 57/04; B64C 27/06; B64C 27/12; B64D 35/00

(52) U.S. Cl. CPC F16H 57/0427; B64C 27/06; B64C 27/12; B64D 35/00; F16H 57/0405; F16H 57/0424; F16H 57/0436; F16H 57/045; F16H 57/0467

(57) ABSTRACT

The present invention relates to at least one main housing (2) which is located on the helicopter between the engine and the rotor and contains the elements for transmitting power from the engine to the rotor; a main shaft (A) that provides power transmission for the movement of the rotor inside the main housing (2); a first housing (201) in which the main shaft (A) is located; a transmission assembly (T) which enables the power from the engine to be transferred to the main shaft (A); a second housing (202) which is located on the main housing (2) in connection with the first housing (201), and contains the transmission assembly (T); a ground (Z) located on the main housing (2) at a distance from the rotor; at least one pump (3) located on the main housing (2) for the lubrication of the main shaft (A) and the transmission assembly (T); at least one reservoir (4) located at or close to the ground (Z) to collect excess oil by gravity; at least one flange (5) for connecting the second housing (202) to the main housing (2), which is located around the pump (3) so as to be connected to the pump (3) on one side and the main housing (2) on the other side.

The present invention relates to a discharge system on a helicopter, which enables the elements for transmitting power to the rotor to be lubricated and collected in a reservoir.

Rotary wing air vehicles comprise at least one rotor which provides a movement thereof and creates the aerodynamic lift, thrust forces and control moments required for the body to remain in the air. Lubrication of the elements for transmitting power from the engine to the rotor is essential for the long-term use of helicopters. Nozzles on the main housing are required for the lubrication of many elements such as the main shaft and/or transmission assembly located in a plurality of housings on the main housing. Nozzles operate in connection with the pump.

European patent document EP2690318, which is included in the known-state of the art, discloses a gear fluid pump intended to passively move upwards the oil from a reservoir in the opposite direction to gravity. It also discloses directing the fluid towards a ball screw through an opening of a bearing house.

Thanks to a fluid discharge system according to the present invention, power transmission elements on the helicopter can be lubricated and the same oil can be used continuously with the same purity.

Another object of the present invention is to prevent oil accumulation on the main housing by transmitting excess oil to the reservoir through an opening between a first housing and a second housing.

Another object of the present invention is to reduce the possibility of excess oil accumulating in the main housing to add extra weight to the air vehicle, to create a potential for chip accumulation and to reach rotating transmission elements during the maneuvers such that it has a destructive effect.

Another object of the present invention is to provide a simple, easy to use, practical and effective fluid discharge system.

The fluid discharge system realized to achieve the object of the invention, which is defined in the first claim and the other claims dependent thereon, comprises at least one engine located on body of the air vehicle and operating by using the fuel for the movement of the body. It comprises at least one rotor system creating a necessary aerodynamic lift force during the take-off motion of the body. It comprises a main housing located on the helicopter between the engine and the rotor, which contains the elements for transmitting power from the engine to the rotor. It comprises a main shaft in the main housing, which provides power transmission for the movement of the rotor; and a transmission assembly that transfers the power from the engine to the main shaft. The main shaft is located on the first housing, and the transmission assembly is located on the second housing. On the main housing, the first housing and the second housing are at least partially interconnected. The discharge system comprises a ground located on the main housing with a distance from the rotor. The ground is located on the main housing, in an opposite direction to the rotor. The discharge system comprises a pump located on the main housing for lubricating the main shaft and transmission assembly; and a reservoir located on the ground or on the main housing near the ground, for collecting excess oil under the effect of gravity. It comprises a flange around the pump, which is connected at one end to the pump and at the other to the main housing to connect the second housing to the main housing or support it. It comprises the flange structure forming an interface between the second housing and the first housing; a ground located on an inner surface of the second housing and the bottom point of which is at a lower elevation than the flange structure, thus collecting the drained oil; the reservoir located on the first housing and having a maximum oil level at lower elevation than the ground.

The fluid discharge system according to the invention comprises the flange with an inclination angle predetermined by the user. When flange and pump are aligned, oil is directed towards the pump due to the form of the flange. The fluid discharge system comprises a gear that extends outward from the pump, and provides power transmission to the transmission assembly. The gear is located between the pump and the transmission assembly. There is a cavity between the pump and the gear. Stagnant oil accumulates in the cavity due to the form of the flange. The flange, which is inclined to direct the oil to the pump, directs the oil into the cavity. The discharge system comprises a flap which is at least partially located on the gear and directs the oil accumulated in the cavity through the flange, away from the flange, with the centrifugal effect thanks to the rotation of the gear around its own axis. The flap is located at a ground-side end point of the gear that is located on the ground and is supported by the first housing or the second housing, wherein the flap rotates with the gear, thus scattering the oil accumulated on the ground out of the flange structure with the centrifugal effect, so that the oil reaches the oil reservoir.

In an embodiment of the invention, the fluid discharge system comprises the opening that allows the oil to be scattered over the flange and transmitted to the reservoir by means of flaps. The opening is located on the main housing, between the first housing and the second housing. The opening is located further away from the ground according to pump, so as to have a distance from the ground.

In an embodiment of the invention, the fluid discharge system comprises a window located on the flange. It comprises the oil that accumulates in the cavity to pass through the window directed to the opening by centrifugal effect. The window is located on the flange closer to the opening.

In an embodiment of the invention, the fluid discharge system comprises at least one locknut which allows the gear to be attached or removed or fixed on the second housing. The locknut surrounds the gear. Flaps are provided on the gear and/or locknut, which extend outward from a side of the gear or locknut facing the pump. The discharge system comprises flaps rotating with the gear; at least one extension extending outward from the flap, which directs the oil first to the window and then to the opening with the effect of the swirl and/or centrifugal effect formed in this region.

In an embodiment of the invention, the fluid discharge system comprises a flat plate-shaped extension that rotates with the gear to create a swirl effect.

In an embodiment of the invention, the fluid discharge system comprises a concave and/or convex plate-shaped extension that rotates with the gear to create a swirl effect. A swirl effect is created by concave and/or convex plate-shaped extensions.

In an embodiment of the invention, the fluid discharge system comprises an extension in the form of a bucket structure. The extensions, each of which are movable differently from the other, transmit oil from the cavity to the window and then to the opening with the swirl effect.

In an embodiment of the invention, the fluid discharge system comprises annular extensions located sequentially with radial angle intervals.

In an embodiment of the invention, the fluid discharge system comprises a channel that surrounds the gear and/or the locknut. The annular channel is provided to effectively direct the oil flow. With the rotation of the gear, oil flow occurs in the channel. A channel opening is provided on the channel in order for the oil flow to be directed towards the opening and leave the channel, wherein the channel opening is located on a side of the channel facing the window and/or the opening. A channel opening is provided on the channel only on the side thereof facing the opening and/or the window.

In one embodiment of the invention, the fluid discharge system comprises the flaps which are integral with the locknut and/or gear.

In one embodiment of the invention, the fluid discharge system comprises the flaps which are mechanically attached to the locknut and/or gear in a removable manner.

In an embodiment of the invention, the fluid discharge system comprises a flange inclined from the opening to the pump inlet port.

In an embodiment of the invention, the fluid discharge system comprises at least one sensor in the reservoir in which all the oil is collected and which allows the oil to be circulated continuously. By means of the sensor, chips, residues etc. in the oil can be detected.

In an embodiment of the invention, in the fluid discharge system, the cavity between the pump and the gear is provided as a flange in the form of a plate. The cavity has a conical form, like a trapezoidal polygon that expands from the pump to the gear.

In an embodiment of the invention, the fluid discharge system comprises a reservoir, wherein the oil accumulated in the cavity passes through the window and the opening respectively, so that it is directed to the reservoir by the effect of gravity. The oil flow, which has been scattered by the swirl effect of the flaps rotating as a result of the rotation of the gear, first passes through the window on the flange, and then it is directed to the opening. The oil flow passing through the opening is enabled to be collected in the reservoir located in the ground or the reservoir located near the ground, with the effect of gravity.

The fluid discharge system realized to achieve the object of the present invention is illustrated in the attached drawings, in which:

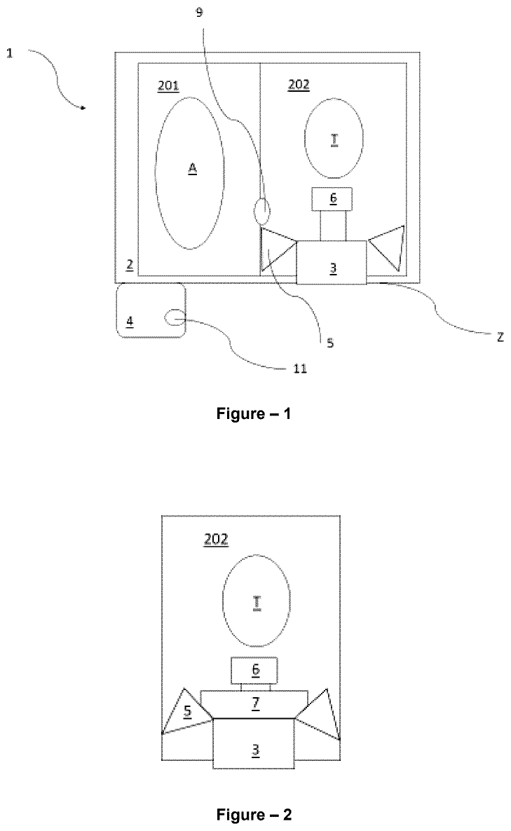

FIG. 1 is a schematic view of the fluid discharge system.

FIG. 2 is a detailed schematic view of the fluid discharge system.

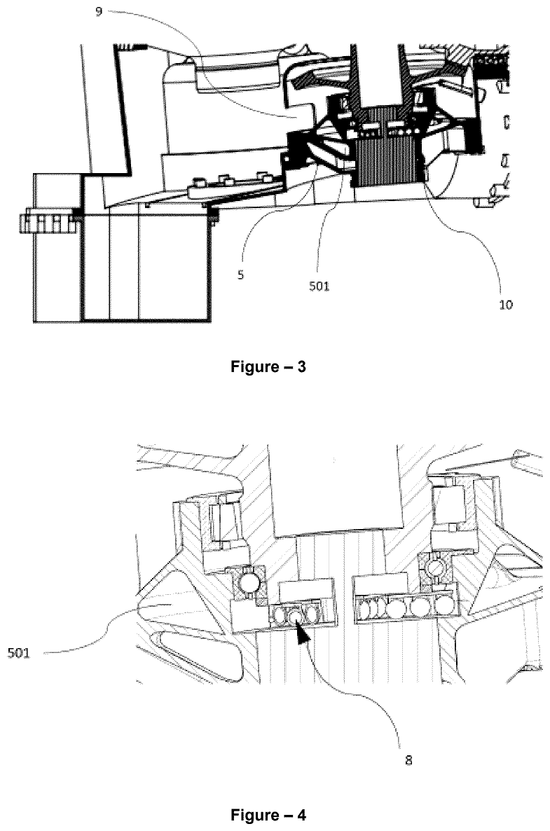

FIG. 3 is a cross-sectional view of the pump, gear and flange.

FIG. 4 is a cross-sectional view of the flap.

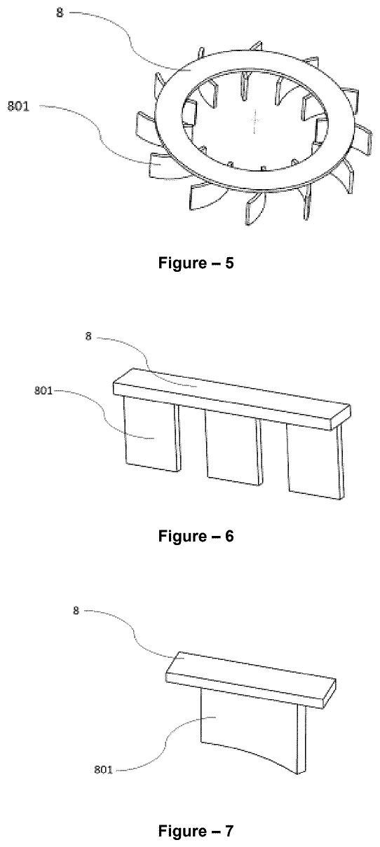

FIG. 5 is a perspective view of the flap.

FIG. 6 is a perspective view of the flat plate-shaped extension.

FIG. 7 is a perspective view of the concave extension.

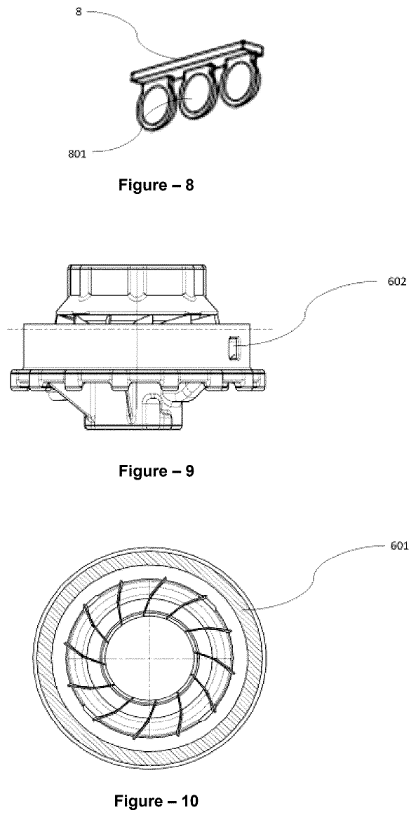

FIG. 8 is a perspective view of the extension in the form of a bucket structure.

FIG. 9 is a front view of the channel opening.

FIG. 10 is a cross-sectional view of the channel structure.

All the parts illustrated in figures are individually assigned a reference numeral and the corresponding terms of these numbers are listed below:
1. Fluid discharge system
2. Main housing
   201. First housing
   202. Second housing
3. Pump
4. Reservoir
5. Flange
501. Window
6. Gear
   601. Channel
   602. Channel opening
7. Cavity
8. Flap
   801. Extension
9. Opening
10. Locknut
11. Sensor
A. Main shaft
T. Transmission assembly
Z. Ground

The fluid discharge system (1) comprises at least one main housing (2) which is located on a helicopter between an engine and a rotor and contains the elements for transmitting power from the engine to the rotor; a main shaft (A) that provides power transmission for the movement of the rotor inside the main housing (2); a first housing (201) in which the main shaft (A) is located; a transmission assembly (T) which enables the power from the engine to be transferred to the main shaft (A); a second housing (202) which is located on the main housing (2) in connection with the first housing (201), and contains the transmission assembly (T); a ground (Z) located on the main housing (2) at a distance from the rotor; at least one pump (3) located on the main housing (2) for the lubrication of the main shaft (A) and the transmission assembly (T); at least one reservoir (4) located at or close to the ground (Z) to collect excess oil by gravity; at least one flange (5) for connecting the second housing (202) to the main housing (2), which is located around the pump (3) so as to be connected to the pump (3) on one side and the main housing (2) on the other side.

The fluid discharge system (1) according to the invention comprises the flange (5) inclined to direct the oil to the pump (3); at least one gear (6) extending outward from the pump (3), located between the pump (3) and the transmission assembly (T), and providing power transmission to the transmission assembly (T); at least one cavity (7) in which the oil between the pump (3) and the gear (6) accumulates; at least one flap (8) which is located at least partially on the gear (6), wherein when the gear (6) rotates around its own axis to create a swirl effect, the oil accumulated in the cavity (7) is directed by the flap (8) away from the flange (5).

There is at least one engine located on the body of the helicopter and operating by using the fuel for the movement of the body; and at least one rotor system that creates a necessary aerodynamic lift force during the take-off movement of the body. The main housing (2) is provided on the helicopter between the engine and the rotor, and contains the elements that provide power transfer from the engine to the rotor. The main shaft (A) that provides power transmission for the movement of the rotor and the transmission assembly (T) that transfers power from the engine to the main shaft (A) are located in the main housing (2). The main shaft (A) is located on the first housing (201) and the transmission assembly (T) is located on the second housing (202). The first housing (201) and the second housing (202) are at least partially interconnected on the main housing (2). The ground (Z) is located on the main housing (2) so as to have a distance from the rotor. Lubrication of the main shaft (A) and transmission assembly (T) is provided by the pump (3) located on the main housing (2). Collection of excess oil with the effect of gravity is provided by the reservoir (4) located on the main housing (2) at the ground (Z) or near the ground (Z). The flange (5) is located around the pump (3) so as to be connected to the pump (3) at one end and to the main housing (2) at the other end, and it is in use to connecting the second housing (202) to the main housing (2) or supporting it.

Thanks to the alignment of the flange (5) and the pump (3) at an inclination angle predetermined by the user, the oil is directed towards the pump (3). Power transfer to the transmission assembly (T) is provided by the gear (6) extending outward from the pump (3). The gear (6) is located between the pump (3) and the transmission assembly (T). In the cavity (7) located between the pump (3) and the gear (6), oil accumulates due to the form of the flange (5). The flange (5) which has an inclination predetermined by the user and directs the oil to the pump (3), directs the oil to the cavity (7). When the gear (6) rotates around its own axis to create a swirl effect, the oil accumulated in the cavity (7) is directed by the flap (8) through on the flange (5) away from the flange (5), and the flap (8) is located at least partially on the gear (6).

In an embodiment of the invention, the fluid discharge system (1) comprises at least one opening (9) located on the main housing (2), between the first housing (201) and the second housing (202), which allows the oil scattered by the flap (8) to be directed to the reservoir (4); the flange (5) with an inclination angle to direct the oil to the opening (9) by means of the swirl effect provided by the flaps (8). Oil accumulated in the cavity (7) is directed by the flap (8) or flaps (8). Transmission of the directed oil to the reservoir (4) is provided by at least one opening (9) located between the first housing (201) and the second housing (202). The oil flow directed to the opening (9) reaches the reservoir (4) with the effect of gravity.

In an embodiment of the invention, the fluid discharge system (1) comprises at least one window (501) located on the flange (5) facing opposite the opening (9), in order to transmit the oil accumulated in the cavity (7) to the opening (9) by centrifugal force by means of the flap (8). Oil accumulated in the cavity (7) is directed by the flap (8) or flaps (8). Transmission of the directed oil to the reservoir (4) is provided by at least one opening (9) located between the first housing (201) and the second housing (202). Thanks to the window (501) located on the flange (5), which is located facing opposite the opening (9), the oil directed from the cavity (7) can reach the opening (9) in a controlled manner.

In an embodiment of the invention, the fluid discharge system (1) comprises at least one locknut (10) which allows the gear (6) to be removably attached to the flange (5); at least one extension (801) located on the flap (8) so as to extend outward from the flap (8) and attached to the gear (6) or locknut (10) on the sides facing the pump (3), wherein the extension (801) rotates with the gear (6) to direct the oil accumulated in the cavity (7) through the window (501) towards the opening (9) under the effect of centrifugal force. The gear (6) is attached to the flange (5) and connected to the transmission assembly (T) on the second housing (202) by means of the locknuts (10). The flaps (8) are located in connection with the gear (6) and/or the locknut (10). The oil accumulated in the cavity (7) by the effect of centrifugal force is directed towards the opening (9) through the window (501), by means of extensions (801) extending outward from the flap (8).

In an embodiment of the invention, the fluid discharge system (1) comprises a flat plate-shaped extension (801) that rotates with the gear (6) to direct the oil flow. Thanks to the fact that the extensions (801) extending outward from the flap (8) are flat plates, efficient oil flow is ensured.

In an embodiment of the invention, the fluid discharge system (1) comprises concave or convex extensions (801) located on the flap (8) as one or more separate plates, which rotate with the gear (6) to direct the oil flow. Thanks to the plurality of concave or convex plate-shaped extensions (801), efficient oil flow is ensured.

In an embodiment of the invention, the fluid discharge system (1) comprises a plurality of extensions (801) in the form of a bucket structure, each of which is movable differently from the other, allowing the oil to be scattered from the cavity (7) to the window (501) with the effect of a swirl. Thanks to the extensions (801), which are in the form of a bucket structure, efficient oil flow is ensured.

In an embodiment of the invention, the fluid discharge system (1) comprises extensions (801) located on the gear (6) and/or the locknut (10) with radial angle intervals predetermined by the user, in order to direct the oil flow. Thanks to the extensions (801), which are located with radial angle intervals, efficient oil flow is ensured.

In an embodiment of the invention, the fluid discharge system (1) comprises at least one channel (601), which surrounds the gear (6) and/or the locknut (10) and enables the oil flow to be directed effectively; at least one channel opening (602) which is located on the channel (601), on a side of the channel (601) facing the opening (9), and allows the oil flow to be transmitted substantially to the opening (9). Thanks to the channel (601) that surrounds the gear (6) and/or the locknut (10), oil accumulated in the cavity (7) is enabled to be collected in the cavity (7) by the swirl effect. The oil that forms a swirl in the channel (601) reaches the window (501) and/or the opening (9) by means of the channel opening (602) located on the side of the channel (601) facing the opening (9).

In an embodiment of the invention, the fluid discharge system (1) comprises the locknut (10) and/or the gear (6), which are integral with the flaps (8). Thanks to the locknut (10) integral with the flaps (8), the system is mechanically more resistant to oil flow impact. The flaps (8) and the extensions (801) can also be produced integrally.

In an embodiment of the invention, the fluid discharge system (1) comprises the locknut (10) and/or the gear (6), to which the flaps (8) are removably attached. Thanks to the flaps (8) removably attached to the gear (6) and/or the locknut (10), it is possible to use different types of designs for the flaps (8).

In an embodiment of the invention, the fluid discharge system (1) comprises the flange (5) which is inclined from the opening (9) to the pump (3). The flange (5), which has an inclination angle predetermined by the user, is angled from the opening (9) towards the pump (3). Due to the angle of inclination of the flange (5), after the lubrication processes of the elements in the main shaft (A) and/or transmission assembly (T), oil accumulation occurs in the cavity (7) due to the effect of gravity.

In an embodiment of the invention, the fluid discharge system (1) comprises at least one sensor (11) located in the reservoir (4) and allowing the detection of residues, chips, etc. in the oil. Thanks to the sensor (11) or sensors (11) located in the reservoir (4), to add extra weight to the air vehicle, to create a potential for chip accumulation and to reach rotating transmission elements during the maneuvers such that it has a destructive effect, can be reduced.

In an embodiment of the invention, the fluid discharge system (1) comprises the conical cavity (7) which expands from the pump (3) to the gear (6). The cavity (7) is in a conical form like a trapezoidal polygon expanding from the pump (3) to the gear (6).

In an embodiment of the invention, the fluid discharge system (1) comprises the reservoir (4), wherein the oil accumulated in the cavity (7) passes through the window (501) and the opening (9) respectively, so that it is directed to the reservoir (4) by the effect of gravity. The oil flow accumulated in the cavity (7), which has been scattered by the swirl effect of the flaps (8) rotating as a result of the rotation of the gear (6) around its own axis, first passes through the window (501) on the flange (5), and then it is directed to the opening (9). The oil flow passing through the opening (9) is enabled to be collected in the reservoir (4) located in the ground (Z) or the reservoir (4) located near the ground (Z), with the effect of gravity.

1. A fluid discharge system comprising at least one main housing which is located on a helicopter between an engine and a rotor and contains the elements for transmitting power from the engine to the rotor; a main shaft (A) that provides power transmission for the movement of the rotor inside the main housing; a first housing in which the main shaft (A) is located; a transmission assembly (T) which enables the power from the engine to be transferred to the main shaft (A); a second housing which is located on the main housing in connection with the first housing, and contains the transmission assembly (T); a ground (Z) located on the main housing at a distance from the rotor; at least one pump located on the main housing for the lubrication of the main shaft (A) and the transmission assembly (T); at least one reservoir located at or close to the ground (Z) to collect excess oil by gravity; at least one flange for connecting the second housing to the main housing, which is located around the pump so as to be connected to the pump on one side and the main housing on the other side, wherein the flange inclined to direct the oil to the pump; at least one gear extending outward from the pump, located between the pump and the transmission assembly (T), and providing power transmission to the transmission assembly (T); at least one cavity in which the oil between the pump and the gear accumulates; at least one flap which is located at least partially on the gear, wherein when the gear rotates around its own axis to create a swirl effect, the oil accumulated in the cavity is directed by the flap away from the flange.

2. A fluid discharge system according to claim 1, wherein at least one opening located on the main housing, between the first housing and the second housing, which allows the oil scattered by the flap to be directed to the reservoir; the flange with an inclination angle to direct the oil to the opening by means of the swirl effect provided by the flaps.

3. A fluid discharge system according to claim 2, wherein at least one window located on the flange facing opposite the opening, in order to transmit the oil accumulated in the cavity to the opening by centrifugal force by means of the flap.

4. A fluid discharge system according to claim 3, wherein at least one locknut which allows the gear to be removably attached to the flange; at least one extension located on the flap so as to extend outward from the flap and attached to the gear or locknut on the sides facing the pump, wherein the extension rotates with the gear to direct the oil accumulated in the cavity through the window towards the opening under the effect of centrifugal force.

5. A fluid discharge system according to claim 4, wherein flat plate-shaped extension that rotates with the gear to direct the oil flow.

6. A fluid discharge system according to claim 4, wherein concave or convex extensions located on the flap as one or more separate plates, which rotate with the gear to direct the oil flow.

7. A fluid discharge system according to claim 4, wherein a plurality of extensions in the form of a bucket structure, each of which is movable differently from the other, allowing the oil to be scattered from the cavity to the window with the effect of swirl.

8. A fluid discharge system according to claim 4, wherein extensions located on the gear and/or the locknut with radial angle intervals predetermined by the user, in order to direct the oil flow.

9. A fluid discharge system according to claim 4, wherein at least one channel, which surrounds the gear and/or the locknut and enables the oil flow to be directed effectively; at least one channel opening which is located on the channel, on a side of the channel facing the opening, and allows the oil flow to be transmitted substantially to the opening.

10. A fluid discharge system according to claim 4, wherein the locknut and/or the gear, which are integral with the flaps.

11. A fluid discharge system according to claim 4, wherein the locknut and/or the gear, to which the flaps are removably attached.

12. A fluid discharge system according to claim 2, wherein the flange which is inclined from the opening to the pump.

13. A fluid discharge system according to claim 1, wherein at least one sensor located in the reservoir and allowing the detection of residues, chips, etc. in the oil.

14. A fluid discharge system according to claim 1, wherein the conical cavity which expands from the pump to the gear.

15. A fluid discharge system according to claim 3, wherein the reservoir, wherein the oil accumulated in the cavity passes through the window and the opening respectively, so that it is directed to the reservoir by the effect of gravity.
